(19) United States
(12) Patent Application Publication
(10) Pub. No.: US 2020/0016590 A1
(43) Pub. Date: Jan. 16, 2020

(54) ANALYSIS DEVICE, CARTRIDGE AND METHOD FOR TESTING A SAMPLE

(71) Applicant: BOEHRINGER INGELHEIM VETMEDICA GMBH, Ingelheim am Rhein (DE)

(72) Inventors: Guenter BRUCKMANN, Wuerselen (DE); Erol MEYDA, Aachen (DE); Jakob MUSTAFA, Herzogenrath (DE); Axel NIEMEYER, Bielefeld (DE); Harald PAULS, Eschweiler (DE); Hannah SCHMOLKE, Didderse (DE); Guenter SCHOLZ, Pulheim-Dansweiler (DE)

(73) Assignee: BOEHRINGER INGELHEIM VETMEDICA GMBH, Ingelheim am Rhein (DE)

(21) Appl. No.: 16/339,426

(22) PCT Filed: Oct. 5, 2017
(86) PCT No.: PCT/EP2017/025282

§ 371 Date: Apr. 4, 2019

(30) Foreign Application Priority Data
Oct. 7, 2016 (EP) 16020374.1

(51) Int. Cl. B01L 3/00

(52) U.S. Cl. CPC B01L 3/50273; B01L 2200/10; B01L 2300/0803; B01L 2300/0816; B01L 2300/0883; B01L 2300/123; B01L 2400/0475; B01L 2300/0832

(57) ABSTRACT

An analysis device, a cartridge and a method for analysing a sample are provided, including a rotatable pump head having contact elements that are resiliently biased in the axial direction acting on an elastically deformable pump chamber in order to pump or convey a fluid, such as the sample, a reagent or a gas, when the pump head rotates, in particular in a defined and/or efficient manner.

### BACKGROUND OF THE INVENTION

### Field of the Invention

The present invention relates to an analysis device, a cartridge and a method for analysing and/or testing a sample, including a pump apparatus for conveying the sample within the cartridge.

Preferably, the present invention deals with analysing and testing a sample, in particular from a human or animal, particularly preferably for analytics and diagnostics, for example with regard to the presence of diseases and/or pathogens and/or for determining blood counts, antibodies, hormones, steroids or the like. Therefore, the present invention is in particular within the field of bioanalytics. A food sample, environmental sample or another sample may optionally also be tested, in particular for environmental analytics or food safety and/or for detecting other substances.

Preferably, at least one analyte (target analyte) of a sample can be determined, identified or detected by means of the cartridge. In particular, the sample can be tested for qualitatively or quantitatively determining at least one analyte, for example in order for it to be possible to detect or identify a disease and/or pathogen.

Within the meaning of the present invention, analytes are in particular nucleic-acid sequences, in particular DNA sequences and/or RNA sequences, or proteins, in particular antigens and/or antibodies. In particular, by means of the present invention, nucleic-acid sequences can be determined, identified or detected as analytes of a sample, or proteins can be determined, identified or detected as analytes of the sample. More particularly preferably, the present invention deals with systems, devices and other apparatuses for carrying out a nucleic-acid assay for detecting or identifying a nucleic-acid sequence or a protein assay for detecting or identifying a protein.

The present invention deals in particular with what are known as point-of-care systems, i.e. those with the option of carrying out tests on site and/or independently from a central laboratory or the like. Preferably, point-of-care systems can be operated autonomously and/or independently of a mains network for supplying electrical power.

### Description of the Related Art

U.S. Pat. No. 5,096,669 discloses a point-of-care system for testing a biological sample, in particular a blood sample. The system comprises a single-use cartridge and an analysis device. The cartridge comprises a receptacle for the sample, it being possible for the receptacle to be closed by a cap once the sample has been received. The cartridge is then inserted into the analysis device in order to carry out the test. The cartridge comprises a microfluidic system and a sensor apparatus comprising electrodes, which apparatus is calibrated by means of a calibration liquid and is then used to test the sample. A waste cavity for receiving liquids is fluidically connected to the sensor apparatus.

Furthermore, International Publication No. WO 2006/125767 A1 and corresponding U.S. Pat. No. 9,110,044 B2 disclose a point-of-care system for integrated and automated DNA or protein analysis, comprising a single-use cartridge, an analysis device comprising a control device and comprising means for receiving and processing signals, the control device being designed to fully automatically process and evaluate molecular-diagnostic analyses using the single-use cartridge.

Usually, pumps, such as peristaltic pumps, are used to convey the sample in point-of-care systems of this kind. For example, EP Patent No. 1 829 568 B1 and corresponding U.S. Pat. No. 8,079,836 B2 disclose a method for operating a peristaltic pump having a roller head which supports a plurality of rollers, the roller head being brought into contact with a flexible fluid channel of a cassette and being rotated such that a plurality of rollers contact the fluid channel and cause fluid to flow through the fluid channel.

US Patent Application Publication No. 2003/0143754 A1 discloses a micro-pump which, in one embodiment, comprises a stiff member angled acutely to a pliable surface in the direction of fluid flow. The stiff member creates a pressure in the direction of flow as it sweeps across the reservoirs and channels. In another embodiment, a pumping mechanism which uses plungers perpendicular to a pliable surface is disclosed. The plungers can collapse a reservoir and channel walls of a cartridge by pressing down on the pliable surface so that the channel wall closes gradually in the direction of the desired fluid flow.

US Patent Application Publication No. 2015/0306596 A1 discloses fluid-control devices which are operated by a peristaltic motion to move a fluid through a conduit. The fluid-control device comprises a deformable portion and an actuator that engages and applies pressure on the deformable portion via at least one rolling element.

US Patent Application Publication No. 2003/0026719 A1 teaches a device for handling fluids in a microfluidic device used in chemical and biochemical analyses. A fluid is delivered by applying an external (mechanical) force on a wall above a microchannel using a rotor with a toothed wheel shape.

U.S. Pat. No. 5,863,502 relates to a device for conducting parallel reactions comprising a cassette with two or more reaction flow-ways. The device further comprises a pump for moving fluids into or out of fluid chambers of the reaction flow-ways. The pump can comprise actuators which push on a supply chamber to open a sealed outlet and to pump fluid into a fluid exchange channel.

### SUMMARY OF THE INVENTION

The problem addressed by the present invention is to provide an improved analysis device, an improved cartridge and an improved method for testing and/or analysing an in particular biological sample, reliable, simple, gentle, hygienic and/or cost-effective testing of the sample, a compact and/or cost-effective construction or design and/or improved conveying of fluid preferably being made possible or facilitated.

The above problem is solved by: an analysis device including a receptacle for a cartridge containing a sample and a pump drive, including a more motor and a pump head driven by the motor, for conveying the sample within the cartridge; a cartridge including a fluid system having a plurality of channels and a pump apparatus for conveying a sample, where in the pump apparatus includes a pump chamber which is elastically deformable or compressible such that contact elements moving over the pump chamber candy for more compressed portions of the pump chamber to convey the sample; or by a method for testing a sample using a pump head including contact elements that project or protrude from a base element acting on a pump apparatus to convey the sample and the pump apparatus by rotating the pump head.

For testing an in particular biological sample, it is proposed that a pump, in particular a peristaltic pump, comprising a pump drive and pump apparatus, is used or formed, the pump drive preferably being in contact or being able to be brought into contact with the pump apparatus at least in part for conveying a sample and/or a fluid.

One aspect of the present invention is that the pump, in particular the pump drive, comprises a pump head that is preferably rotatable and/or formed in one piece, the pump head comprising a plurality of, in particular at least two, three or four and/or at most ten, eight or six, contact elements, the contact elements being designed, at least during the pumping, to be placed on, rest on or act on the pump apparatus, in particular a pump chamber of the pump apparatus, and/or to be moved in a sliding manner over the pump apparatus.

Preferably, the contact elements are elastically deformable and/or are each resiliently mounted and/or are held resiliently by the pump head. In this way, particularly reliable, simple and/or gentle conveying or pumping of a sample and/or a fluid is made possible or facilitated. In particular, any damage to the pump apparatus is prevented or reduced and/or the service life of the pump drive is increased.

Preferably, the pump head comprises a base element wherein the contact elements can each be moved relative to the base element, wherein the pump head is formed together with the contact elements in one piece. This allows a very simple, cost-effective and robust construction.

According to another aspect of the present invention, the contact elements are designed such that the contact elements rest on or can be brought into contact with the pump apparatus or pump chamber in a linear manner and/or with edges in order to convey the sample. This allows in particular a very effective pumping.

According to another aspect of the present invention, the pump chamber is provided with an intermediate layer and/or a sliding layer for the contact elements. This facilitates sliding of the contact elements over the pump chamber or its wall to convey a fluid or the sample within the pump chamber or associated cartridge.

A method according to the present invention provides that the contact elements are moved in a sliding manner on the pump apparatus and/or over a pump chamber.

According to one aspect of the present invention, the contact elements are each elastically deformed upon contact with the pump apparatus. This allows a very effective pumping while the drive force, in particular for rotating the pump head and/or moving the contact elements over the pump chamber can be minimized, in particular for the one-piece construction of the pump head as preferred.

According to another aspect of the present invention, the contact element slides over the pump apparatus with contact in a linear manner and/or with respective edges in order to convey the sample. This allows very precise and effective pumping.

According to a further aspect of the present invention, the contact elements slide over an intermediate layer and/or a sliding layer additionally arranged between the contact elements and the pump chamber. This supports an effective pumping and/or minimizes friction.

Further, an analysis system is proposed which comprises a proposed analysis device and at least one cartridge for the sample. In particular, the analysis system is designed as a kit comprising the analysis device and at least one cartridge.

A kit within the meaning of the present invention is preferably a group and/or analysis system comprising the analysis device and at least one cartridge. The analysis device and the cartridge preferably each form a component of the kit.

The components of the kit are preferably marketed as a group, in particular in the same packaging or the like. It is however also possible for the aforementioned components to form a group of separate components for joint use. A common or unifying component is preferably provided, for example common operating instructions, recommendations for use or references on the labelling of one or more of the components of the kit and/or the common packaging. The proposed analysis system or kit optionally comprises at least a pair of gloves, operating instructions, a transfer apparatus such as a syringe, pipette or the like, and/or an extractant or solvent.

The term “analysis device” is preferably understood to mean a structural apparatus designed to chemically, biologically and/or physically test and/or analyse a sample or analysis sample or a component thereof, in particular in order for it to be possible to directly and/or indirectly detect or identify a disease and/or pathogen. An analysis device within the meaning of the present invention is in particular a portable or mobile device designed in particular to directly test and/or analyse the sample, in particular on site and/or in the vicinity of the sampling site and/or away from a central laboratory.

The proposed analysis device preferably comprises a receptacle for a cartridge containing a sample. In particular, the cartridge containing the sample can be inserted into the analysis device in order for the sample to be analysed and/or can be moved, displaced or pressed towards or against the pump head in the analysis device, or vice versa. It is however also possible for the cartridge to be connected or connectable to the analysis device in another manner. For example, the cartridge can also be put on or next to the analysis device or attached to the side of the analysis device.

Preferably, the analysis device comprises the pump drive for conveying or pumping the sample, a reagent and/or another fluid within the cartridge and/or the analysis device.

The pump drive preferably comprises an in particular electric drive or motor, it preferably being possible for the pump head to be driven, in particular rotated, by means of the motor.

Preferably, the cartridge received by the analysis device can be moved, in particular displaced or pressed, relative to the pump head and/or towards or against the pump head, or can be positioned against said pump head or vice versa, preferably such that the pump head is in contact with the cartridge and/or the pump apparatus at least in part.

In particular, the pump drive or pump head and the cartridge, in particular the pump apparatus or a pump chamber of the pump apparatus, can be brought into contact with one another and/or connected and disconnected from one another as desired.

Particularly preferably, any asperities or surface roughness on the cartridge and/or on the pump apparatus or pump chamber can in each case be compensated for at least in part by the contact elements, and/or the pump head can be adapted to the surface of the cartridge or of the pump apparatus or pump chamber. Advantageously, the susceptibility of the pump and/or analysis device to errors can be reduced and/or reliable or defined conveying can be achieved.

The term “cartridge” is preferably understood to mean a structural apparatus or unit designed to receive, to store, to physically, chemically and/or biologically treat and/or to measure a preferably biological sample. A cartridge within the meaning of the present invention preferably comprises a fluidic system or fluid system having a plurality of channels, cavities and/or valves for controlling the flow through the channels and/or cavities. In particular, within the meaning of the present invention, a cartridge is designed to be at least substantially planar, flat and/or card-like, in particular is designed as a fluidic card and/or is designed as a support and/or container for the sample that can be inserted and/or plugged into the proposed analysis device.

Preferably, the cartridge comprises the pump apparatus, by means of which or within which the sample, a reagent and/or another fluid can be conveyed or pumped.

Preferably, the pump apparatus can be driven or actuated by means of the pump drive of the analysis device. Particularly preferably, the pump apparatus or the pump chamber thereof is flexible or elastically deformable, in particular compressible, at least in part, preferably by means of the pump drive and/or pump head.

Preferably, the pump apparatus and/or pump chamber is designed to straighten up, to enlarge and/or to return to its original shape again, in particular automatically and/or by means of a preferably hydraulic or pneumatic action or apparatus, following deformation.

More particularly preferably, the pump drive of the analysis device and the pump apparatus of the cartridge together form a pump, in particular a hose pump or peristaltic pump, the pump drive preferably being fluidically, in particular hydraulically, separated from the pump apparatus. In this way, particularly hygienic testing of the sample is made possible, and any contamination of the analysis device is prevented.

The proposed method for analysing an in particular biological sample is characterised in that the contact elements are moved on the pump apparatus and/or over the pump chamber in a sliding or non-rolling manner. Advantageously, a simple, compact, stable and/or low-maintenance construction is thus made possible or facilitated.

Preferably, asperities or surface roughness on the cartridge and/or the pump apparatus are compensated for in a resilient manner by the pump drive, in particular the contact elements, and/or the contact elements each elastically deform upon contact with the pump apparatus. This can result in corresponding advantages. In particular, any manufacturing tolerances of the cartridge and/or oscillations or vibrations that are generated for example by other components of the analysis device can be compensated for or minimized.

The above-mentioned aspects and features of the present invention and the aspects and features of the present invention that will become apparent from the claims and the following description can in principle be implemented independently from one another, but also in any combination.

Other aspects, advantages, features and properties of the present invention will become apparent from the claims and the following description of a preferred embodiment with reference to the accompanying drawings.

### BRIEF DESCRIPTION OF THE DRAWINGS

FIG. 1 is a schematic plan view of a proposed cartridge;

FIG. 2 is a schematic section through the cartridge in the region of a receptacle or receiving cavity for a sample in the open state, with a transfer apparatus connected;

FIG. 3 is a schematic view of a proposed analysis system comprising the cartridge according to FIG. 1 and a proposed analysis device;

FIG. 4 is a perspective view of a proposed pump head of the analysis device according to FIG. 3;

FIG. 5 is a schematic section through a proposed pump according to a first embodiment;

FIG. 6 is a schematic section through a proposed pump according to a second embodiment;

FIG. 7 is a schematic plan view of the proposed pump according to FIG. 5; and

FIG. 8 is a schematic section through a proposed pump according to a third embodiment.

### DETAILED DESCRIPTION OF THE INVENTION

In the following description, the same reference signs are used for the same and similar parts and components, resulting in corresponding properties and features even if these are not repeatedly described.

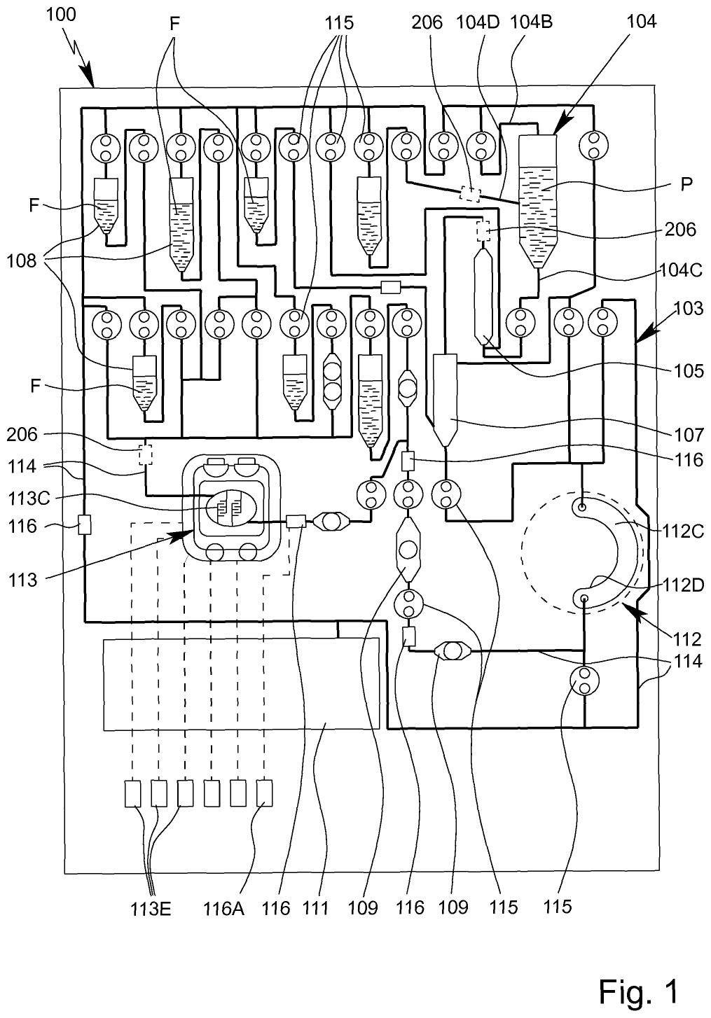

FIG. 1 is a highly schematic view of a preferred embodiment of a proposed cartridge 100 for testing an in particular biological sample P.

The term “sample” is preferably understood to mean the sample material to be tested, which is in particular taken from a human or animal. In particular, within the meaning of the present invention, a sample is a fluid, such as saliva, blood, urine or another liquid, preferably from a human or animal, or a component thereof. Within the meaning of the present invention, a sample may be pretreated or prepared if necessary, or may come directly from a human or animal or the like, for example. A food sample, environmental sample or another sample may optionally also be tested, in particular for environmental analytics, food safety and/or for detecting other substances, preferably natural substances, but also biological or chemical warfare agents, poisons or the like.

A sample within the meaning of the present invention preferably contains one or more analytes, it preferably being possible for the analytes to be identified or detected, in particular qualitatively and/or quantitatively determined. Particularly preferably, within the meaning of the present invention, a sample has target nucleic-acid sequences as the analytes, in particular target DNA sequences and/or target RNA sequences, and/or target proteins as the analytes, in particular target antigens and/or target antibodies. Particularly preferably, at least one disease and/or pathogen can be detected or identified in the sample P by qualitatively and/or quantitatively determining the analytes.

The cartridge 100 comprises a receptacle or receiving cavity 104 for the sample P. Further details will be given later on a preferred construction of this receptacle or receiving cavity 104.

The cartridge 100 comprises a fluidic, preferably microfluidic, system 103, referred to in the following as the fluid system 103, which is fluidically connected to the receptacle or receiving cavity 104.

The cartridge 100 and/or the fluid system 103 preferably comprises at least one pump apparatus 112, at least one storage cavity 108 for a reagent, in the example shown in particular a plurality of storage cavities 108 for different liquid reagents F, at least one measuring or metering cavity 105, at least one mixing cavity 107, at least one treatment or reaction cavity 109, a collection or equalisation cavity 111 and/or at least one sensor apparatus 113.

The cartridge 100 and/or the fluid system 103 in particular comprises channels 114, valves 115 and/or sensors or sensor portions 116.

Particularly preferably, the fluid system 103 is formed by the cavities 105, 107 to 109, 111 and the channels 114.

The channels 114 are preferably designed to fluidically interconnect the receptacle or receiving cavity 104, the pump apparatus 112, the cavities 105, 107 to 109, 111 and/or the sensor apparatus 113 and/or to connect these as desired and/or selectively.

The valves 115 are preferably designed to control, in particular to allow, to prevent, to reduce and/or to increase, preferably temporarily or permanently as desired, the flow rate or fluid flows, in particular of the sample P and/or of the reagent F or reagents F and/or of gas or air, through the channels 114, cavities 105, 107 to 109, 111, the pump apparatus 112, the sensor apparatus 113 and/or the sensors or sensor portions 116, as explained in greater detail in the following.

The cartridge 100 preferably comprises an in particular at least substantially planar, flat, plate-shaped and/or card-like support or main body 101, the support or main body 101 preferably being made of and/or injection-moulded from plastics material.

Preferably, the cavities 105, 107 to 109, 111, the channels 114, the valves 115 and/or the pump apparatus 112 are formed by corresponding depressions and/or raised portions in the support or main body 101.

More particularly preferably, the cartridge 100 comprises a film or cover 102, the support or main body 101 preferably being connected at least in part to the film or cover 102, in particular in a bonded manner, and/or being covered at least in part by the film or cover 102, preferably in a gas-tight manner.

In particular, the depressions in the support or main body 101 are covered and/or closed by the film or cover 102, and/or the raised portions are formed by the film or cover 102 and/or a (local) bulge of the film or cover 102.

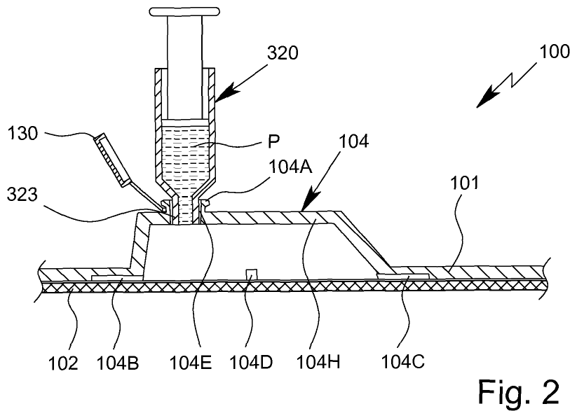

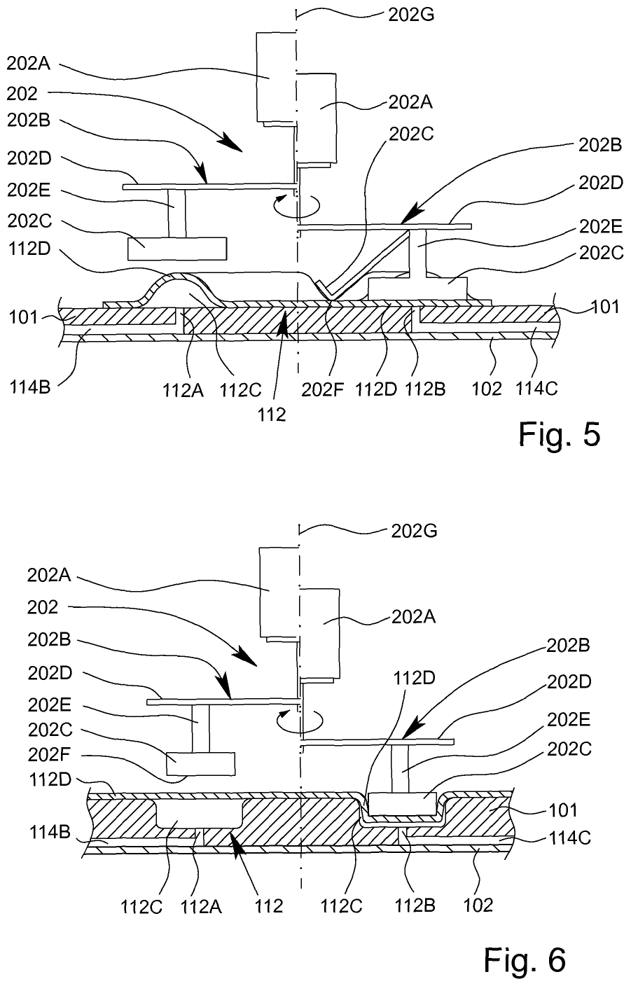

Particularly preferably, the cavities 105, 107 to 109, 111, the channels 114, the valves 115 and/or the pump apparatus 112 and/or the walls thereof are formed by the depressions and/or raised portions in or on the support or main body 101 and by the film or cover 102, as shown schematically in FIG. 2 for the channels 104B, 104C and 104D, and in FIGS. 5 and 6 for the pump apparatus 112. However, other structural solutions are also possible.

FIG. 2 is a highly schematic partial section through the cartridge 100 in the region of the receptacle or receiving cavity 104.

Preferably, the cartridge 100, in particular the support or main body 101, comprises a depression 104H, which in particular forms the receiving cavity 104, and which is covered by the film or cover 102 in this case. Additionally or alternatively, the film or cover 102 forms the receiving cavity 104 and/or depression 104H, preferably so as to be raised from the support or main body 101 or the surface thereof.

The receptacle or receiving cavity 104 preferably comprises a connection 104A for receiving the sample P. In particular, a transfer apparatus 320, in this case preferably comprising a connection 323, in particular a connecting tip, can be connected to the receptacle or receiving cavity 104 or the connection 104A thereof, as shown schematically in FIG. 2, in order to fill the receptacle or receiving cavity 104 with the sample P.

The transfer apparatus 320 may for example be a syringe, a pipette, a tube or the like.

FIG. 2 shows the receptacle or receiving cavity 104 when still empty, i.e. before receiving the sample P.

Once the sample P has been received, the receptacle or receiving cavity 104 can preferably be closed fluidically and in particular also in a gas-tight manner. In the example shown, the receptacle or receiving cavity 104 preferably comprises a closure element 130 for this purpose, which in this case is designed in particular as a latched, screwed or hinged lid.

Once the sample P has been received, the transfer apparatus 320 is removed from the receptacle or receiving cavity 104 or the connection 104A and the receptacle or receiving cavity 104 or the connection 104A thereof is closed by the closure element 130.

The fluid system 103 is preferably connected to the receptacle or receiving cavity 104 and/or the depression 104H by means of a connection channel or outlet 104C for receiving and/or discharging the sample P, as shown schematically in FIGS. 1 and 2.

Furthermore, the fluid system 103 is preferably connected to the receptacle or receiving cavity 104 or the depression 104H thereof via a ventilation channel or inlet 104B and/or flushing channel or intermediate connection 104D, such that the sample P or at least a component thereof can be conveyed out of the receptacle or receiving cavity 104 or depression 104H, in particular via the connection channel or outlet 104C, in particular without a (relevant) vacuum developing in the receptacle or receiving cavity 104.

If required, a gas or air can be fed to the receptacle or receiving cavity 104 via the ventilation channel or inlet 104B and/or a liquid, for example a reagent F, can be fed to said receptacle or receiving cavity 104 via the flushing channel or intermediate connection 104D, in order to convey the sample P or a component thereof into the fluid system 103, the connection channel or outlet 104C and/or a downstream cavity 105, 107, 109 and/or into the sensor apparatus 113.

The sample P or a component thereof is conveyed out of the receptacle or receiving cavity 104 into the fluid system 103 preferably by suction and/or by overpressure (feeding gas and/or liquid into the receptacle or receiving cavity 104). This is in particular facilitated or made possible by locking, sealing and/or closing the receptacle or receiving cavity 104 and/or the fluid system 103, preferably in a gas-tight manner.

The sample P or a component thereof is particularly preferably conveyed by means of the pump apparatus 112 and/or by accordingly controlling the valves 115.

Preferably, the pump apparatus 112 comprises at least one pump chamber 112C and/or the pump apparatus 112 is formed by at least one pump chamber 112C.

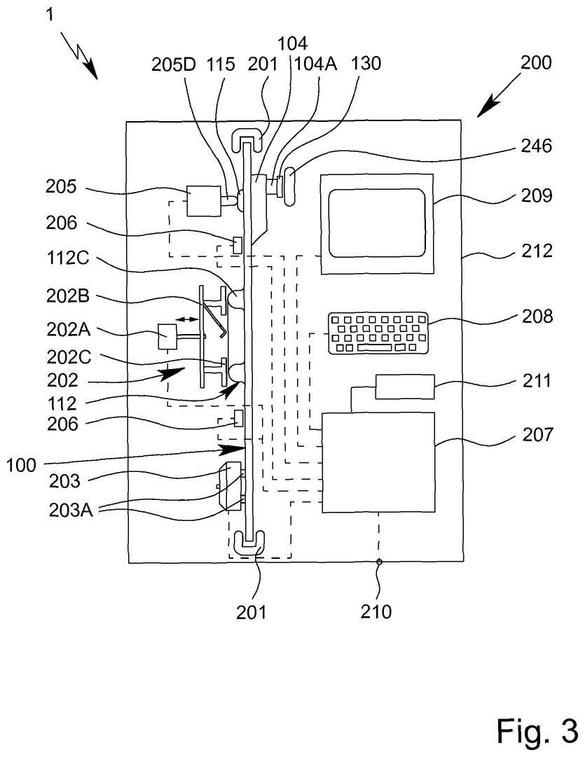

The pump chamber 112C is preferably designed as a raised portion and/or depression on or in the cartridge 100, in particular the support or main body 101, as shown in particular in FIGS. 3, 5 and 6.

Preferably, the pump apparatus 112 and/or the pump chamber 112C comprises a wall 112D that is flexible and/or elastically deformable at least in part, the wall 112D in particular being formed by a film, for example the film or cover 102.

Preferably, the pump apparatus 112 and/or the pump chamber 112C is elastically deformable, in particular compressible, at least in part and/or in portions. In particular, the wall 112D can be pressed onto the support or main body 101 or the surface thereof, the wall 112D or the pump chamber 112C then preferably being reset and/or enlarged again, automatically and/or by a counterforce and/or by a restoring, deflecting or manipulating apparatus (not shown).

The pump chamber 112C, in particular the wall 112D, is preferably bulged and/or raised relative to the support or main body 101 or the surface thereof and/or is formed as a bead. However, other solutions are also possible here, as explained in the following with reference to FIG. 6.

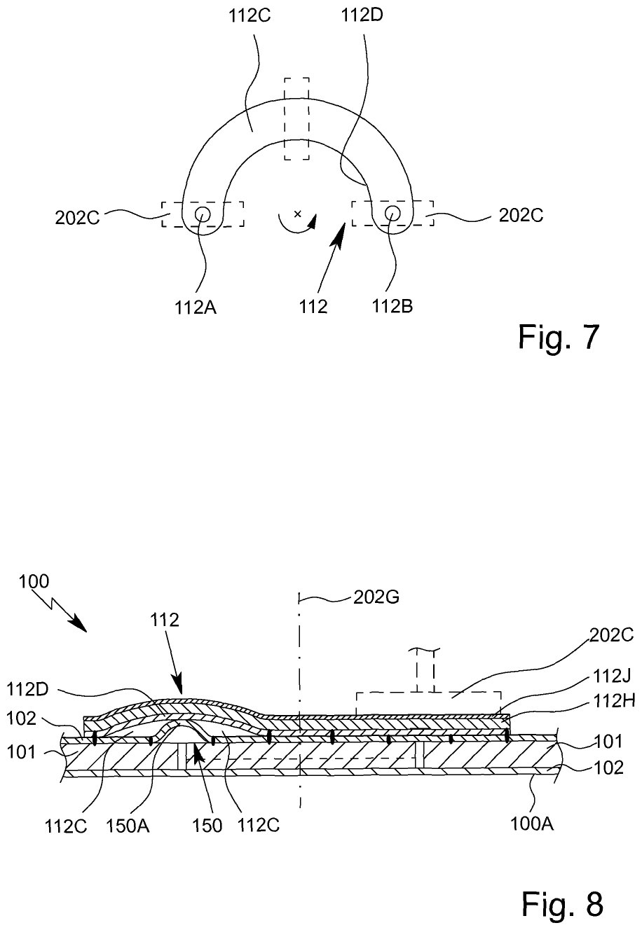

Preferably, the pump chamber 112C is curved, in particular is arcuate, in the shape of an arc of a circle or a circle, and/or is formed as an arc or as (part of) a circle, particularly preferably on the support or main body 101, as shown in FIGS. 1 and 7.

The angle enclosed between the two ends of the pump chamber 112C and/or the angle at the centre is preferably greater than 90°, particularly preferably greater than 120° or 150°, in particular at least substantially 180°, and/or less than 360°, particularly preferably less than 280°, in particular less than 220°.

In an alternative embodiment (not shown), the pump chamber 112C is formed as a ring or is annular, in particular is formed as a toroid, the pump chamber 112C preferably comprising, in particular between an inlet and an outlet for a fluid that is to be conveyed, a partition wall, which prevents the fluid from circulating within and/or flowing back into the pump chamber 112C and/or from the outlet to the inlet.

The pump chamber 112C preferably has and/or defines a volume, in particular a pump volume, for a fluid, in particular the sample P and/or the reagent F, it preferably being possible for the volume to be changed, in particular to be reduced at least temporarily.

The volume of the pump chamber 112C is preferably greater than 0.05 ml or 0.1 ml, particularly preferably greater than 0.2 ml or 0.5 ml, in particular greater than 1 ml, and/or less than 10 ml, particularly preferably less than 5 ml, in particular less than 2 ml.

Particularly preferably, a fluid, in particular the sample P and/or the reagent F and/or a gas, can be conveyed through the pump chamber 112C, in particular by temporarily changing the pump volume of the pump chamber 112C and/or by deforming, in particular compressing, the pump chamber 112C, the wall 112D and/or the film or cover 102 in portions and/or temporarily.

The pump apparatus 112 or pump chamber 112C preferably comprises an inlet opening or inlet 112A and an outlet opening or outlet 112B and/or is preferably fluidically connected to an inlet channel 114B and an outlet channel 114C, preferably by means of an inlet or inlet opening 112A and an outlet or outlet opening 112B, respectively.

The inlet 112A is preferably arranged on a first end of the pump chamber 112C and the outlet 112B is preferably arranged on a second end thereof. However, other solutions are also possible here.

The conveying direction can preferably be reversed. Depending on the operation of the pump apparatus 112, it is in particular possible for the inlet 112A to operate or be used as the outlet, at least temporarily, and for the outlet 112B to operate or be used as the inlet, at least temporarily.

In the embodiment shown, the cartridge 100 comprises just one pump apparatus 112, the pump apparatus 112 preferably making it possible, depending on the valves 115, to convey the fluid, in particular the sample P and/or the reagent F, through all the cavities 105, 107 to 109 and 111, channels 114 and valves 115. However, other structural solutions are also possible in which the cartridge 100 comprises a plurality of pump apparatuses 5 and/or pump chambers 112C.

Preferably, the pump apparatus 112 and/or pump chamber 112C is designed to make it possible to test the sample P, to convey the sample P, reagents F, other fluids and/or gas, to mix the sample P with reagents, in particular liquid reagents F, and/or to treat the sample P in another way, and/or is designed to control the (dynamic) pressure and/or speed of the fluid, in particular of the sample P and/or the reagent F, through all the cavities 105, 107 to 109 and 111, channels 114 and valves 115.

Once the receptacle or receiving cavity 104 has been closed, the fluid system 103 forms, in particular together with the receptacle or receiving cavity 104 and/or the connected cavities 105, 107 to 109 and 111, channels 114, the pump apparatus 112, pump chamber 112C and/or the sensor apparatus 113, a closed circuit for fluids, in particular gas, air and/or liquids. This is facilitated or made possible by the receptacle or receiving cavity 104 and/or the fluid system 103 being locked, sealed and/or closed, preferably in a gas-tight manner.

The sensor apparatus 113 is designed in particular for electrochemically measuring the prepared sample P. In particular, the sensor apparatus 113 comprises a corresponding biochip or functionalised chip or the like.

The sensor apparatus 113 in particular comprises electrodes 113C that particularly preferably engage in one another in a finger-like manner and/or form a plurality of electrode pairs and/or measurement points. Particularly preferably, the sensor apparatus 113 and/or the chip is constructed as described in U.S. Pat. No. 7,123,029 B2 or U.S. Pat. No. 7,914,655 B2.

The sensor apparatus 113 preferably operates electrically and/or electrochemically. In particular, the cartridge 100 and/or the support or main body 101 comprises electrical contacts 113E for electrically connecting the sensor apparatus 113, as shown schematically in FIG. 1.

As already explained, the cartridge 100 and/or the fluid system 103 preferably comprises one or more sensors or sensor portions 116, in particular for detecting a flow front and/or for detecting the presence of a liquid, or for measuring the pH or another value, measuring the temperature or the like.

Preferably, the cartridge 100 and/or the support or main body 101 comprises corresponding electrical contacts 116A for electrically connecting the sensors or sensor portions 116, just one electrical contact 116A for electrically contacting or connecting an assigned sensor or sensor portion 116 being schematically shown in the view according to FIG. 1 for reasons of simplicity.

As an alternative or in addition to the sensors or sensor portions 116, one or more sensors 206 may also be provided that are in particular used for detecting a flow front and/or for detecting the presence of a liquid, for measuring the temperature or other values or the like, the sensors 206 preferably not forming part of the cartridge 100, but instead being arranged on or in an assigned analysis device 200, as explained in greater detail in the following.

FIG. 3 shows a proposed analysis system or kit 1 comprising the proposed analysis device 200 and the proposed cartridge 100.

Preferably, the analysis device 200 and the assigned cartridge 100 form the proposed analysis system or kit 1 for testing an in particular biological sample P.

The cartridge 100 can preferably be connected to the analysis device 200 and/or can be received by the analysis device 200 at least in part. Particularly preferably, the cartridge 100 can be plugged into the analysis device 200. However, other structural solutions are also possible.

FIG. 3 shows the analysis system 1 in the ready-to-use state for carrying out a test on the sample P received in the cartridge 100. In this state, the cartridge 100 is therefore linked to, received by or plugged into the analysis device 200.

The view in FIG. 3 is merely schematic, in order to illustrate essential functions and/or aspects.

In the example shown, the analysis device 200 preferably comprises a mount or receptacle 201, such as a slot or the like, for receiving and/or mounting the cartridge 100. However, other structural solutions are also possible.

Preferably, the cartridge 100 is fluidically, in particular hydraulically, separated or isolated from the analysis device 200. In particular, the cartridge 100 forms, together with the receptacle or receiving cavity 104, a preferably independent and in particular closed fluidic and/or hydraulic system and/or fluid system 103 for the sample P.

Preferably, the cartridge 100 is merely electrically connected to the analysis device 200. However, in principle or in addition, an optical, mechanical, thermal and/or pneumatic coupling is also possible or provided, in particular for measurement purposes.

The test and/or the test sequence in the cartridge 100 is preferably controlled electrically, thermally and/or mechanically, and/or the effect of the analysis device 200 on the cartridge 100 is preferably electrical, thermal and/or mechanical.

Preferably, the pump apparatus 112, pump chamber 112C and/or valves 115 are actuated mechanically by the analysis device 200.

Particularly preferably, the analysis device 200 only has a mechanical effect on the cartridge 100, in particular the pump apparatus 112, pump chamber 112C and/or valves 115, in particular in order to make possible or bring about the desired preparation and/or treatment and testing of the sample P in the cartridge 100 and/or the analysis device 200.

In addition, if required, the analysis device 200 may also have a thermal effect on the cartridge 100 and/or the test sequence and/or the sample P, i.e. for example may temperature-control a treatment or reaction cavity 109 in a desired manner, it also being possible in particular for thermal cycles to be run in order for it to be possible to, for example, carry out a PCR (polymerase chain reaction) in the cartridge 100.

Additionally or alternatively, if required, the cartridge 100 may also comprise a temperature-control or heat-generation apparatus, such as a heating element, thermal element, thermocouple or the like, which can in particular be electrically supplied and/or controlled by the analysis device 200.

The analysis device 200 preferably comprises a pump drive 202, the pump drive 202 in particular being designed for mechanically actuating the pump apparatus 112 and/or pump chamber 112C on or in the cartridge 100.

Preferably, the pump apparatus 112 can be driven by means of the pump drive 202, in particular from the outside. In particular, the pump drive 202 is designed to interact with the pump apparatus 112 and/or pump chamber 112C such that the sample P, the reagent F and/or another fluid or gas can be conveyed and/or pumped within the cartridge 100 and/or the analysis device 200.

Preferably, the pump drive 202 is fluidically, in particular hydraulically, separated from the pump apparatus 112 and/or pump chamber 112C, in particular by means of the wall 112D of the pump apparatus 112.

Preferably, the pump drive 202 of the analysis device 200 and the pump apparatus 112 and/or pump chamber 112C of the cartridge 100 together form a pump, in particular a hose pump or peristaltic pump, it preferably being possible for the sample P, the reagent F and/or another fluid to be conveyed, pumped and/or pressurised within the pump apparatus 112 and/or pump chamber 112C by externally mechanically deforming the pump chamber 112C and/or the wall 112D.

For example, the pump may be constructed as described in DE Patent No. 10 2011 015 184 B4 and corresponding to US Patent Application Publication No. 2013/0087226 A1. However, other structural solutions are also possible.

The pump drive 202 preferably comprises an in particular electrical drive and/or motor 202A and a pump head 202B, it preferably being possible for the pump head 202B to be driven by means of the motor 202A, preferably in a rotary or linear manner.

Preferably, the pump head 202B can rotate about an axis of rotation 202G, the axis of rotation 202G preferably being oriented at least substantially orthogonally to the cartridge 100 and/or a main plane of extension of the cartridge 100 and/or support or main body 101, at least during conveying and/or pumping. However, other structural solutions are also possible in which the axis of rotation 202G is oriented at least substantially in parallel with the cartridge 100 and/or a main plane of extension of the cartridge 100.

In an alternative embodiment (not shown), the pump head 202B can preferably be moved linearly and/or in a straight line, in particular such that the pump head 202B moves on the cartridge 100 and/or pump chamber 112C in an at least substantially straight conveying direction. For example, the pump drive 202 can be designed as or comprise a traction mechanism drive, the pump head 202B preferably being formed by the traction mechanism.

Preferably, the cartridge 100 can be moved, in particular displaced, relative to the pump drive 202, in particular the pump head 202B, or vice versa, in particular in order to drive and/or actuate the pump apparatus 112.

The pump drive 202 and the pump apparatus 112 can be interconnected and disconnected from one another as desired, preferably by displacing or moving the cartridge 100 relative to the pump drive 202 and/or pump head 202B, or vice versa.

Preferably, the pump drive 202 and/or the pump head 202B is moved away from the cartridge 100, in particular the pump apparatus 112 or pump chamber 112C, in a first position, and is, at least in part, positioned and/or pressed against the cartridge 100, in particular the pump apparatus 112 or pump chamber 112C, in a second position.

In particular, the cartridge 100 can be moved or displaced from the first position, or the position in which it is moved away from the pump head 202B, into the second position, and/or, starting from the first position, can be pressed onto or against the pump head 202B.

Particularly preferably, in the second position the pump drive 202 and/or the pump head 202B is positioned, at least in part, on the cartridge 100, in particular the pump apparatus 112 or pump chamber 112C, and/or in the second position the pump drive 202 and/or the pump head 202B compresses the pump chamber 112C at least in part and/or in portions.

In an alternative embodiment (not shown), the drive and/or motor 202A is designed to move or displace the pump head 202B relative to and/or towards the cartridge 100, in addition to being designed to rotate. In particular, structural solutions are also possible in which the analysis device 200 comprises an additional motor, such as a stepper motor or the like, in order to move the entire pump drive 202 and/or the motor 202A together with the pump head 202B relative to the cartridge 100.

Preferably, at least in the second position, the pump drive 202, in particular the pump head 202B, is operatively connected to the pump chamber 112C on an end face and/or by a side remote from the motor 202A.

The pump head 202B is preferably at least substantially planar and/or disc-like.

Particularly preferably, the pump head 202B comprises a plurality of, in particular at least two, three or four and/or at most eight or ten, contact elements 202C, at least one contact element 202C, particularly preferably several or all of the contact elements 202C, preferably being placed on or resting on the cartridge 100, pump chamber 112C or wall 112D and/or acting thereon, in particular in the axial direction and/or the direction of rotation, at least in the second position and/or during pumping.

In the embodiment shown, the pump head 202B comprises four contact elements 202C. However, other structural solutions are also possible in which the pump head 202B comprises fewer than or more than four contact elements 202C. Other structural solutions are also possible in which the pump head 202B only comprises one contact element 202C.

In the second position, the pump head 202B is preferably in direct contact only with the pump chamber 112C and/or wall 112D. In particular, in the second position the pump head 202B is also arranged at a distance from the support or main body 101 and/or only the contact elements 202C that are placed on or rest on the pump chamber 112C and/or wall 112D are in contact with the cartridge 100. This reduces wear on components that move relative to one another.

Alternatively, in the second position the pump head 202B is in contact with both the pump chamber 112C or wall 112D and the support or main body 101 or regions of the film or cover 102 next to the pump chamber 112C, and/or in the second position all of the contact elements 202C are in contact with the cartridge 100, in particular at least one contact element 202C, preferably several contact elements 202C, being placed on or resting on the pump chamber 112C or wall 112D, and the other contact element 202C or the other contact elements 202C being placed on or resting on the support or main body 101 or the region next to the pump chamber 112C.

The pump head 202B preferably comprises a base element 202D, the base element 202D preferably being at least substantially planar and/or disc-shaped and/or extending at least substantially radially relative to the axis of rotation 202G.

Preferably, the pump head 202B, in particular the base element 202D, can be plugged onto the motor 202A and/or is connected to the motor 202A in a form-fitting, interlocking, force-fitting and/or bonded manner. In particular, the pump head 202B can be replaced and/or removed from the motor 202A. This makes it possible to perform maintenance on and/or to replace a faulty pump head 202B.

The contact elements 202C preferably project from the base element 202D in the axial direction and/or towards the cartridge 100 and/or the pump chamber 112C.

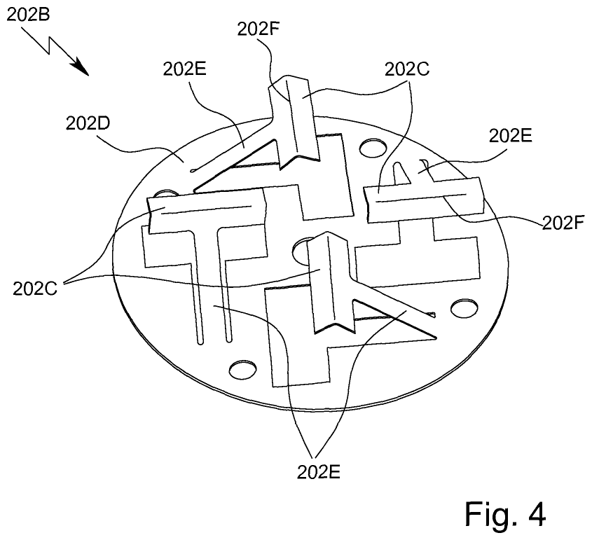

Particularly preferably, the contact elements 202C are connected to the base element 202D by means of respective connection elements 202E, as shown in particular in FIG. 4.

The pump head 202B is preferably formed in one piece or forms a unit. In particular, the contact elements 202C, the base element 202D and the connection elements 202E are formed in one piece, or the contact elements 202C, the base element 202D and the connection elements 202E form a unit.

The pump head 202B is preferably made of plastics material or metal. In the embodiment shown, the contact elements 202C, together with the respective connection elements 202E, are cut and/or bent out from the base element 202D. However, other solutions are also possible here.

Preferably, the contact elements 202C and/or connection elements 202E can (each) be moved relative to the base element 202D, can (each) be elastically deformed and/or are (each) resiliently connected to the base element 202D.

Preferably, the contact elements 202C can be deflected from an untensioned position into a tensioned position.

Particularly preferably, the pump head 202B and/or the contact elements 202C is/are untensioned in the first position and/or tensioned and/or elastically deformed, in particular pressed axially against the pump head 202B or the base element 202D, in the second position.

In particular, the pump head 202B forms a resilient component, the spring constant of the pump head 202B preferably being less than 10 kN/m, particularly preferably less than 5 kN/m or 1 kN/m, in particular less than 800 N/m or 500 N/m, and/or greater than 1 N/m or 10 N/m, particularly preferably greater than 50 N/m, in particular greater than 100 N/m.

Preferably, the contact elements 202C can each be moved relative to the base element 202D, are each resiliently mounted, can each be deformed elastically and/or biased or pretensioned towards the cartridge 100 or pump apparatus 112, individually and/or independently from one another.

In particular, the contact elements 202C can be deformed elastically and/or biased or pretensioned to different extents. This makes it possible for the pump head 202B to be adapted to and/or positioned against the surface and/or outer contour of the cartridge 100 or pump chamber 112C.

The contact elements 202C are preferably elongate, scoop-like and/or spoon-like.

Particularly preferably, the contact elements 202C are (each) designed as a slider or sliding element and/or are designed so as not to roll and/or are designed to be moved on the cartridge 100 and/or pump apparatus 112 in a sliding and/or non-rolling manner. This allows or facilitates a particularly simple construction of the pump head 202B.

The contact elements 202C preferably comprise at least one, preferably two, bevels and/or the contact elements 202C are bevelled in relation to the axis of rotation.

Particularly preferably, the contact elements 202C have a V-shaped or U-shaped cross section. This provides for particularly gentle pumping and/or compression of the pump chamber 112C or wall 112D, and/or prevents or minimizes damage, in particular to the flexible wall 112D.

Preferably, the contact elements 202C are designed such that, when in contact with the pump chamber 112C or wall 112D and/or during pumping, they each are placed on or rest on the pump chamber 112C and/or wall 112D in a line and/or by an in particular radially extending edge or contact edge 202F, and/or such that they act on the pump chamber 112C or wall 112D, and/or such that they each form or comprise a contact edge 202F.

Preferably, the pump drive 202 and/or the pump apparatus 112 is designed to convey and/or pump the sample P, the reagent F and/or another fluid in any direction. In particular, the pump head 202B can be driven, in particular rotated, in two opposing directions. Advantageously, the possible uses of the pump drive 202 are thus increased.

Preferably, the contact elements 202C and/or the connection elements 202E are arranged so as to be offset and/or spaced apart from the axis of rotation 202G (cf. FIGS. 5 and 6) and/or arranged on an edge or in an edge region of the base element 202D.

In particular, the contact elements 202C and/or the connection elements 202E are arranged in a circle on the base element 202D and/or in a circle around the axis of rotation 202G.

Preferably, the contact elements 202C or contact edges 202F or the longitudinal extensions thereof are oriented at least substantially in parallel with the base element 202D and/or a main plane of extension of the cartridge 100 and/or orthogonally to the axis of rotation 202G, in particular independently from any movement of the contact elements 202C relative to the base element 202D.

In particular, the contact elements 202C are connected to the base element 202D and/or mounted thereon such that the contact elements 202C are arranged and/or oriented so as to always be at least substantially parallel to the base element 202D and/or such that they remain always at least substantially parallel to the base element 202D, even when said contact elements 202C and/or the connection elements 202E are elastically deformed and/or when there is relative movement between the contact elements 202C and the base element 202D. This provides for particularly efficient pumping by means of the pump drive 202, even when the contact elements 202C are moved relative to the base element 202D.

Preferably, the contact elements 202C are each arranged transversely to the connection elements 202E and/or the contact elements 202C point, in the longitudinal extension thereof, towards the axis of rotation 202G.

Preferably, the connection elements 202E or the respective longitudinal extensions of the connection elements 202E are oriented at least substantially tangentially to a common circle, at least in a plan view of the pump head 202B.

In the embodiment shown, the connection elements 202E are oriented in relation to one another in the manner of a rectangle, at least in a plan view of the pump head 202B. However, other solutions are also possible here.

The connection elements 202E are preferably oriented obliquely to the base element 202D or a main plane of extension of the base element 202D and/or the cartridge 100 or a main plane of extension of the cartridge 100.

Particularly preferably, the angle enclosed in each case between the connection elements 202E or the respective longitudinal axes of the connection elements 202E on the one hand and the base element 202D or a main plane of extension of the base element 202D and/or the cartridge 100 or a main plane of extension of the cartridge 100 on the other hand is greater than 00 or 15°, in particular greater than 20° or 30°, and/or less than 90° or 80°, in particular less than 60° or 50°.

In particular, the contact elements 202C are connected to the base element 202D such that said contact elements 202C can be pivoted relative to the base element 202D and/or moved on an arc of a circle.

FIG. 5 shows the pump or pump arrangement both when separated (left-hand side) and when in the operating state or during pumping (right-hand side). On the left-hand side of FIG. 5, the pump drive 202 or pump head 202B is separated or moved away from the cartridge 100, in particular the pump apparatus 112, and is therefore in the first position. Conversely, on the right-hand side of FIG. 5, the cartridge 100 is pressed against the pump drive 202 or pump head 202B and/or the pump head 202B is connected to the cartridge 100, in particular the pump apparatus 112, and is therefore in the second position.

In the first embodiment shown of the pump, the pump apparatus 112 and/or pump chamber 112C is preferably arranged on the support or main body 101 and/or is raised relative to the support or main body 101.

As shown in FIG. 5 and FIG. 7, in the first embodiment shown, the contact elements 202C are wider than the pump chamber 112C in the radial direction. However, other solutions are also possible, in particular those in which the contact elements 202C are shorter than the pump chamber 112C in the radial direction, as shown in FIG. 6.

The contact elements 202C are preferably designed to cut off, suspend and/or compress the pump chamber 112C and/or to deform the wall 112D in portions, locally and/or at least in part, and/or to press the wall 112D onto the surface of the support or main body 101.

In particular, a volume inside the pump chamber 112C can be enclosed and/or fluidically separated by means of two adjacent contact elements 202C and/or can be moved or conveyed, preferably from the inlet 112A to the outlet 112B or vice versa, by rotating the pump head 202B in the rotational direction.

The pump and/or the pump drive 202 is preferably designed to convey the sample P, the reagent F and/or a gas continuously and/or successively or in intervals. Particularly preferably, metered amounts or volumes of the sample P, the reagent F and/or a gas can be conveyed by means of the pump or pump drive 202.

Preferably, after the wall 112D has been compressed, the sample P, the reagent F and/or another fluid can be drawn into the pump chamber 112C and/or received therein again, preferably from the inlet channel 114B, and by means of the wall 112D being subsequently expanded or reset, in particular automatically and/or locally or in portions, and/or by said wall being pretensioned.

In a particularly preferred embodiment (not shown), the analysis system 1 and/or the cartridge 100 comprises a restoring, deflecting or manipulating apparatus, the deflecting or manipulating apparatus preferably being arranged below the pump chamber 112C at least in part and/or being designed to enlarge the pump chamber 112C again and/or to raise the wall 112D from the support or main body 101, preferably by means of pressurised air.

FIG. 6 shows the pump or pump arrangement both when separated (left-hand side) and when in the operating state or during pumping (right-hand side). On the left-hand side of FIG. 6, the pump drive 202 or pump head 202B is separated or moved away from the cartridge 100, in particular the pump apparatus 112, and is therefore in the first position. Conversely, on the right-hand side of FIG. 6, the cartridge 100 is moved, displaced or pressed against the pump drive 202 or pump head 202B, and is therefore in the second position.

In the alternative second embodiment of the pump shown in FIG. 6, the pump chamber 112C is preferably integrated in the support or main body 101 and/or is formed as a depression in the support or main body 101. In this embodiment, the wall 112D is preferably arranged so as to be at least substantially planar and/or parallel to the surface of the support or main body 101, at least when the cartridge 100 is in the first position.

Preferably, portions of the wall 112D can be pressed into the depression in the support or main body 101 by the contact elements 202C, as shown on the right-hand side of FIG. 6.

The pump head 202B is in particular designed to be continuously in contact with the cartridge 100, via the elastic and/or resiliently mounted contact elements 202C, during rotational movement, and/or to press the contact elements 202C into the depression in the support or main body 101 during rotational movement.

The respective ends of the pump chamber 112C are optionally bevelled, preferably such that the contact elements 202C can be moved over the pump chamber 112C at least substantially stepless or continuously.

In particular, the wall 112D and/or the depression in the support or main body 101 can each have bevels in the rotational direction, which preferably allow the contact elements 202C to be moved or guided over the pump chamber 112C and/or in the depression in the support or main body 101 in an even, stepless, continuous and/or gentle manner.

FIG. 8 shows a third embodiment in a section that is similar to that in FIG. 5 and FIG. 6. FIG. 8 shows, by way of example, just one contact element 202C of the pump head 202B or pump drive 202.

In the third embodiment, an intermediate layer 112H and/or a sliding layer 112J is arranged between the pump apparatus 112, the pump chamber 112C and/or the flexible wall 112D of the pump chamber 112C on one side and the pump head 202B and/or the contact elements 202C on the other side.

Particularly preferably, the intermediate layer 112H and/or the sliding layer 112J is arranged on the cartridge 100, pump apparatus 112 and/or wall 112D.

In particular, the intermediate layer 112H covers the pump apparatus 112, pump chamber 112C and/or wall 112D on the pump-head side.

In particular, the sliding layer 112J is arranged on the optional intermediate layer 112H on the pump-head side. Alternatively, however, the sliding layer 112J may in particular also be arranged on or attached to the pump head 202B or contact elements 202C, in particular in the region of the contact edges 202F.

The intermediate layer 112H is preferably thicker and/or softer or more flexible than the wall 112D and/or the sliding layer 112J. Preferably, the intermediate layer 112H is more than twice or three times as thick as the wall 112D and/or the sliding layer 112J.

The intermediate layer 112H is preferably used or provided to even out the force effect of the pump head 202B on the pump apparatus 112, the pump chamber 112C and/or the wall 112D during pumping.

The intermediate layer 112H preferably consists of plastics material and/or a film sheet, and/or is adhesively bonded, for example.

The sliding layer 112J is designed to be particularly smooth and/or is used or provided to reduce the sliding friction during pumping. In particular, the sliding layer 112J makes it easier for the pump head 202B or the contact elements 202C to slide on the pump apparatus 112 than it would be if said pump head 202B or contact elements 202C were sliding on the wall 112D or the intermediate layer 112H.

The sliding layer 112J is preferably made of plastics material and/or is formed by a thin film and/or is adhesively bonded, for example.

The sliding layer 112J preferably covers the pump apparatus 112, the pump chamber 112C and/or the wall 112D over the entire surface thereof or at least in the region of the sliding path of the contact elements 202C.

In the third embodiment, the cartridge 100 and/or pump apparatus 112 preferably comprises a restoring, deflecting or manipulating apparatus 150 for positioning, deflecting or restoring the pump chamber 112C and/or wall 112D.

The cartridge 100 and/or manipulating apparatus 150 preferably comprises a raised portion or manipulating or deflecting element 150A, it preferably being possible for the pump chamber 112C to be enlarged by means of the manipulating element 150A and/or for the wall 112D to be raised by means of the manipulating element 150A.

In the example shown, for this purpose the wall 112D is formed by a film sheet arranged on the film or cover 102 therebelow, such that the pump chamber 112C can be formed therebetween by appropriate welding, two pump channels 112C in particular being formed or extending here substantially in parallel with one another on either side of the raised portion or manipulating element 150A of the manipulating apparatus 150. The raised portion or manipulating element 150A is formed by the film or cover 102 and is in particular raised pneumatically in order to raise the pump chamber 112C and/or to bias or pretension said chamber 112C against the pump head 202B and/or the contact elements 202C. However, other structural solutions are also possible here.

The restoring, deflecting or manipulating apparatus 150 is preferably designed to enlarge the pump chamber 112C (again) following deformation and/or to raise the wall 112D and/or push said wall 112D away from the support or main body 101.

Preferably, a working medium, in particular gas, air or a liquid, is or can be admitted to the manipulating apparatus 150 and/or the manipulating apparatus 150 is or can be driven by the working medium.

Particularly preferably, the manipulating apparatus 150 is designed as a pneumatic or hydraulic counter bearing, in particular an air cushion, for the pump, in particular the pump drive 202 and/or pump head 202B, as explained in greater detail in the following.

The manipulating apparatus 150 is preferably arranged below the pump apparatus 112 or pump chamber 112C and/or between the pump apparatus 112 or pump chamber 112C and the support or main body 101 in a plan view of the cartridge 100.

Preferably, at least one valve 115 (not shown in FIG. 5 to FIG. 8) is assigned to the pump apparatus 112 and/or arranged in front of, behind or in the pump apparatus 112.

Preferably, one valve 115 is provided at the inlet 112A and/or at the outlet 112B of the pump apparatus 112, in particular in order to control the flow of fluid through the pump chamber 112C and/or to prevent fluid from flowing back out of the pump chamber 112C or in the direction opposite the conveying direction.

The analysis system 1, the cartridge 100 and/or the pump apparatus 112 may therefore generally, thus in particular also in the other embodiments, comprise an intermediate layer 112H, a sliding layer 112J and/or a manipulating apparatus 150 in the above-mentioned sense. In particular, the above-mentioned restoring or deflecting apparatus may comprise some or all features of the manipulating apparatus 150.

In the following, other aspects that are also generally applicable to all the embodiments are discussed.

According to one aspect of the present invention, which can also be implemented independently, the analysis system 1, analysis device 200 and/or the method for testing an in particular biological sample P is preferably characterised in that the pump head 202B is rotatable or rotated such that the contact elements 202C are pulled over the pump apparatus 112, the pump chamber 112C and/or the wall 112D. In the rotational direction, the connection of the contact element 202C via its connection element 202E to the base element 202D thus extends in the rotational direction in front of the trailing contact edge 202F of the relevant contact element 202C. In this case, the sliding friction produced between the contact elements 202C and the pump apparatus 112 during pumping does not lead to an increase in the force exerted on the pump apparatus 112, the pump chamber 112C and/or the wall 112D perpendicularly to the rotational plane of the contact elements 202C. This has proven advantageous in particular in terms of the pumping performance and/or the required motor performance. However, alternatively or additionally, the opposite rotational direction may also be used.

The valves 115 or some of the valves 115 can be designed to be self-closing and/or automatically opening, as required, for example when a particular pressure is reached or exceeded.

Furthermore, individual valves 115 may also be designed as non-return valves or check valves.

In addition, some, a plurality or all of the valves 115 may also be designed such that they open and/or close (only) by mechanical actuation.

Particularly preferably, at least one valve 115 is assigned to the pump apparatus 112 and/or is arranged upstream of, downstream of or in the pump apparatus 112.

Preferably, one valve 115 is provided at the inlet 112A and/or at the outlet 112B of the pump apparatus 112, in particular in order to control the flow of fluid through the pump chamber 112C and/or to prevent fluid from flowing back out of the pump chamber 112C or in the direction opposite the conveying direction.

The analysis device 200 preferably comprises an actuator 205 which has an actuation element 205D used or provided to actuate the assigned valve 115. In particular, the actuation element 205D can act on a flexible wall of the valve 115, such as the film or cover 102 or the like, in order to actuate said valve. However, other structural solutions are also possible.

The analysis device 200 preferably comprises a connection apparatus 203 comprising connections or contact elements 203A for electrically connecting the cartridge 100 and/or electrical contacts 113E and/or 116A. In this case, an electrical plug-in connection or another electrical connection or the like, which is preferably automatically established or made when the cartridge 100 is received in the analysis device 200, may also be formed in principle.

The analysis device 200 preferably comprises a control apparatus 207 for controlling the sequence of a test and/or for evaluating and/or outputting and/or providing test results.

The analysis device 200 optionally comprises an input apparatus 208, such as a keyboard, a touch screen or the like. Alternatively or additionally, this may be an interface for example for enabling control by means of a smartphone, a laptop, an external keyboard or the like.

The analysis device 200 preferably comprises a display apparatus 209, such as a screen. Alternatively or additionally, this may be an interface for example for outputting test results to external devices, to a smartphone, a laptop, an external screen or the like.

The analysis device 200 preferably comprises an interface 210, for example for outputting test results and/or for connecting to other devices or the like. This may in particular be a wired or wireless interface 210.

For example, a printer may also be connected to the interface 210 in order to output results. Alternatively or additionally, a printer (not shown) may also be integrated in the analysis device 200 or may be formed by the display apparatus 209.

The analysis device 200 preferably comprises a power supply apparatus 211, which is in particular integrated or externally connected. This may in particular be a battery or an accumulator and/or power pack.

For mobile use, the analysis device 200 and/or the power supply apparatus 211 may in particular be designed such that it can be directly connected to the on-board power supply of a motor vehicle, i.e. can be operated at 12 or 14 V DC current for example.

The analysis device 200 preferably comprises a housing 212. Particularly preferably, the cartridge 100 can be inserted or slid into the housing 212 through an opening (not shown), such as a slot or the like.

The different apparatuses 207 to 209 and/or 211, the motor 202A and/or the actuator 205 is/are preferably arranged in the housing 212.

The analysis device 200 is preferably portable or mobile.

The analysis device 200 preferably comprises a retaining element 246, which is assigned to the receptacle or receiving cavity 104, connection 104A or closure element 130 in order to keep the receptacle or receiving cavity 104, the connection 104A thereof or the closure element 130 closed or to secure them in the closed position, when the cartridge 100 is received, as shown merely schematically in FIG. 3.

The analysis device 200 preferably comprises one or more sensors 206, in particular for monitoring or controlling the test sequence, as shown schematically in FIG. 3. For example, a liquid front or the presence of liquid in a channel or cavity can be detected, for example optically or capacitively, by means of a sensor 206.

The sensors 206 may be provided in addition to or as an alternative to the sensors or sensor portions 116 arranged on the cartridge 100.

In the following, a preferred sequence of a test using the proposed cartridge 100 and/or the proposed analysis device 200 and/or analysis system 1 and/or in accordance with the proposed method is explained in greater detail.

Preferably, a test is carried out on site, i.e. independently from a central laboratory or the like, for example by a veterinarian or another doctor. Preferably, the present invention is thus used as a point-of-care system.

A sample P is preferably received by the receptacle or receiving cavity 104 of the cartridge 100. For this purpose, the receptacle or receiving cavity 104 or the closure element 130 thereof is preferably first opened. The sample P is then preferably manually introduced or inserted into the receptacle or receiving cavity 104 or placed therein, in particular by means of the transfer apparatus 320.

Once the sample P has been received, the receptacle or receiving cavity 104 or the connection 104A thereof, as well as the vent 104E, if provided, are fluidically closed by the closure element 130, in particular in a liquid-tight and gas-tight manner.

The cartridge 100 is (then) preferably connected to the analysis device 200, in particular is inserted or slid into said analysis device.

Preferably, the cartridge 100 is moved, displaced or pressed relative to the pump head 202B or towards the pump head 202B, or vice versa, such that all the contact elements 202C rest on the cartridge 100 and/or at least one contact element 202C, preferably some or all of the contact elements 202C, rests/rest on the pump chamber 112C or wall 112D.

In particular, the cartridge 100 is moved far enough that the pump head 202B, in particular some or all of the contact elements 202C and/or connection elements 202E, is/are elastically deformed, and/or, at least in part, adapted to and/or pressed onto the surface of the cartridge 100 and/or the pump chamber 112C.

The pump is then activated or the pump head 202B is driven or rotated, in particular in order to start the test or analysis of the sample P.

During pumping, the contact elements 202C are preferably moved on or over the pump chamber 112C in a sliding manner, the contact elements 202C preferably elastically deforming, in particular pushing in or compressing, the pump chamber 112C and/or wall 112D at least in portions.

The contact elements 202C are preferably resiliently mounted such that any asperities or surface roughness on the cartridge 100 can be compensated for at least in part by said contact elements 202C during rotation.

Particularly preferably, the contact elements 202C are moved on the cartridge 100 under tension, preferably such that said elements always exert a contact pressure on the cartridge 100 and/or pump chamber 112C and/or wall 112D.

The sample P, the reagent F and/or another fluid is/are preferably conveyed from the inlet 112A to the outlet 112B, or vice versa, by the action of the pump head 202B and/or the contact elements 202C.

The sample P in the cartridge 100 is then tested in the analysis device 200, preferably at least largely in an automated manner or automatically.

The sample P is removed from the receptacle or receiving cavity 104 or depression 104H at least in part, in this case via the connecting channel or outlet 104C.

In order to cause said sample to be removed and/or to prevent negative pressure from building up in the receptacle or receiving cavity 104, a fluid, in particular air or another gas or a liquid, such as a flushing liquid or the like, is fed to the receptacle or receiving cavity 104, in particular via the ventilation channel or inlet 104B and/or flushing channel or intermediate connection 104D, preferably by means of the pump, the pump apparatus 112 and/or the pump drive 202.

In order to convey the sample P out of the receptacle or receiving cavity 104, the pump or pump apparatus 112 can generate negative pressure on the outlet side and/or overpressure in the receptacle or receiving cavity 104 on the inlet side, in particular via the ventilation channel or inlet 104B and/or flushing channel or intermediate connection 104D. Here, if required, the relatively large collection cavity 111 can be used as a pressure storage means for applying pressure to the receptacle or receiving cavity 104 and/or for equalising the pressure.

The sample P is treated, prepared and/or metered and/or added to or mixed with reagents, in particular liquid reagents F, in the desired or required manner in the cartridge 100.

For example, the sample P is first fed to the measuring or metering cavity 105 for metering, preferably by means of the pump, the pump apparatus 112 and/or the pump drive 202.

The sample P is then preferably fed to a mixing cavity 107 and mixed with a reagent or a plurality of reagents, in particular a liquid reagent F or a plurality of liquid reagents F, for example in order to dilute the sample P, to adjust the pH, to lyse cells and/or to carry out other reactions, preferably by means of the pump, the pump apparatus 112 and/or the pump drive 202.

The reagents may also be provided or introduced as dry reagents if required.

The sample P is then preferably fed to at least one treatment or reaction cavity 109, for example in order for a PCR or other treatment to be carried out therein, preferably by means of the pump, the pump apparatus 112 and/or the pump drive 202. Here too, corresponding reagents, in particular liquid reagents F, may again be added or mixed in if required.

The PCR or other treatment may take place or be carried out at specified temperatures. The cartridge 100, the analysis device 200 and/or the proposed analysis system 1 is preferably designed such that the desired temperatures or temperature profiles for the sample P are achieved, maintained or passed through in the respective cavities and channels. In particular, corresponding temperature control or regulation is provided or implemented.

The method sequence, in particular the flow and conveying of the liquids, the mixing and the like, is/are controlled by the analysis device 200 and/or the control apparatus 207, in particular by accordingly activating or actuating the pump drive 202 or pump apparatus 112 and the valves 115.

The analysis device 200 and/or the control apparatus 207 thereof can detect liquid states, for example a liquid front or the presence of liquid, in particular by means of the sensors or sensor portions 116 and/or sensors 206, and can accordingly take this into account for the control.

Additionally or alternatively, also optical detection or measurement can be carried out, for example for the presence of liquid, the fill level of a cavity or the like.

The collection cavity 111 is used in particular to receive excess or used liquids, such as the sample P, reagents F or the like. Alternatively or additionally, the collection cavity 111 is optionally also used for pressure equalisation, since, after the receptacle or receiving cavity 104 has been closed, a fluidically completely closed circuit is preferably formed on or in the cartridge 100.

The collection cavity 111 preferably comprises a flexible or elastically deformable wall, which is in particular formed by the film or cover 102 or the like, in particular in order to make the above-mentioned pressure equalisation possible. However, other structural solutions are also possible.

The prepared sample P or components thereof, for example amplified DNA sequences, is/are lastly fed to the sensor apparatus 113, preferably by means of the pump, the pump apparatus 112 and/or the pump drive 202.

Preferably, the sample P is then in particular electrochemically measured, for example for the presence of at least one desired target analyte.

The preferably electrical measurement is controlled by the analysis device 200 or the control apparatus 207 and/or the sensor apparatus 113. The test results or measurement results are in particular electrically transmitted to the analysis device 200 or the control apparatus 207 thereof, and are accordingly prepared, analysed, stored and/or displayed, in particular by the display apparatus 209.

After the test has been carried out, the cartridge 100 is removed from the analysis device 200 again and is preferably disposed of.

The fluid system 103 is preferably designed as a microfluidic system. The same preferably also applies to the cartridge 100, which is in particular designed as a microfluidic cartridge.

In the present invention, the term “microfluidic” is preferably understood to mean volumes of less than 1 ml, particularly preferably less than 0.5 ml, in individual cavities or channels or in a plurality of or all of said cavities or channels.

Preferably, no external liquids have to be fed in or provided while the test is being carried out. This minimizes the risk of inadvertent contamination of the surroundings or the analysis device 200. At the same time, the sensitivity to external disturbances is reduced, since no additional substances need to be introduced in addition to the sample P.

Preferably, the storage cavities 108 are closed by mechanically actuated valves 115, and not by what are known as capillary stops or the like. This also increases the robustness of the cartridge 100 and maintains its functionality.

The cartridge 100 and/or the support or main body 101 is preferably produced in an injection-moulding process, particularly preferably from polypropylene, in particular with the depressions, which are preferably only made on one side and are intended to form the cavities and channels, preferably being covered by the film or cover 102 only on one side, or on both sides if required, and said cavities and channels being formed in a desired manner as a result. However, other structural solutions are also possible.

Particularly preferably, a plurality of or different closed (gas-tight) circuits are formed on or in the cartridge 100 for different fluids, liquids, reagents F and/or for the sample P, depending on the state of the valves 115 of the fluid system 103, for example a circuit for conveying the sample (receptacle or receiving cavity 104, outlet 104C, connecting channel, cavity 105, channel 114, cavity 107, channel 114, pump apparatus 112, channel 114 and back to the receptacle or receiving cavity 104 via the ventilation channel and/or inlet 104B) and a circuit for conveying the reagents F (a cavity 108, channel 114, cavity 107, channel 114, pump apparatus 112 and channel 114 back to the cavity 108).

A plurality or all of the circuits can preferably be operated by the same pump apparatus 112.

One or more circuits are in particular formed by the fluid system 103 together with the receptacle or receiving cavity 104, in order to transfer the sample P from the receptacle or receiving cavity 104 into the fluid system 103.

One or more circuits are preferably formed without the receptacle or receiving cavity 104, i.e. only in the fluid system 103.

The different circuits are used for example to convey the sample P, to treat the sample P with one or more reagents, in particular liquid reagents F, to feed the treated sample P to the sensor apparatus 113, to flush one or more cavities, or the like.

An analysis system 1, an analysis device 200 and a method for analysing an in particular biological sample P is proposed, a rotatable pump head 202B comprising contact elements 202C that are resiliently or elastically biased or pretensioned in the axial direction acting on an elastically deformable pump chamber 112C in order to pump or convey a fluid, such as the sample P, a reagent F or a gas, when the pump head 202B rotates, in particular in a defined and/or efficient manner.

Individual aspects and features of the present invention and individual method steps may be implemented independently from one another, but also in any desired combination and/or order.

In particular, the present invention relates also to any one of the previous aspects and the following claims, but can also be realized independently:
1. Analysis system for testing an in particular biological sample,
the analysis system comprising a fluid system having a plurality of channels, a pump apparatus for conveying the sample and/or a fluid, a sensor apparatus for testing the sample or at least a component thereof, and a pump drive for driving the pump apparatus,
the pump drive comprising a motor and a pump head that can be driven by means of the motor,
the pump head comprising a plurality of contact elements and being in contact or being able to be brought into contact with the pump apparatus at least in part, in order to convey the sample and/or a fluid,
characterized
in that the contact elements can be moved in a sliding manner over the pump apparatus, and/or in that the pump head is formed in one piece.
2. Analysis system according to aspect 1, characterised in that the analysis system comprises a cartridge for receiving the sample, the cartridge preferably comprising an at least substantially planar support and/or being designed to be card-like, and/or comprising the fluid system, the pump apparatus and/or the sensor apparatus.
3. Analysis system according to aspect 1 or 2, characterised in that the pump drive and the pump apparatus form a pump, in particular a hose pump or peristaltic pump, and/or can be interconnected or disconnected from one another as desired.
4. Analysis system according to any one of the preceding aspects, characterised in that the contact elements are designed such that the contact elements rest on or can be brought into contact with the cartridge, in particular the pump apparatus, in a linear manner and/or with respective edges, in order to convey the sample.
5. Analysis system according to any one of the preceding aspects, characterised in that the pump apparatus comprises a pump chamber, the pump chamber preferably being elastically deformable, in particular compressible, at least in part and/or in portions, preferably by means of the pump head and/or the contact elements, and/or the pump chamber preferably being curved, in particular being in the shape of a circular arc.
6. Analysis system according to any one of the preceding aspects, characterised in that an intermediate layer and/or a sliding layer is additionally arranged between the contact elements on one side and the pump apparatus, a pump chamber or the wall thereof on the other side.
7. Analysis system according to any one of the preceding aspects, characterised in that the analysis system comprises an analysis device for testing the sample, the analysis device preferably being designed according to any one of claims 8 to 11.
8. Analysis device for testing an in particular biological sample,
the analysis device comprising a receptacle for a cartridge containing the sample and a pump drive for conveying the sample and/or a fluid within the cartridge and/or the analysis device,
the pump drive comprising a motor and a pump head that can be driven, in particular rotated, by means of the motor,
the pump head comprising a plurality of contact elements, and
the cartridge, in particular a pump apparatus of the cartridge, being in contact or being able to be brought into contact with the pump head at least in part,
characterized
in that the contact elements can be moved in a sliding manner over the pump apparatus, and/or
in that the pump head is formed in one piece.
9. Analysis device according to aspect 8, characterised in that the pump head comprises a preferably disc-shaped base element, the contact elements projecting from the base element and/or each being resiliently connected to the base element and/or each being able to be moved relative to the base element.

10. Analysis device according to aspect 8 or 9, characterised in that the contact elements are scoop-like and/or spoon-like and/or are at least substantially V-shaped or U-shaped in cross section and/or are each designed as a slider or sliding element.
11. Analysis device according to any one of aspects 8 to 10, characterised in that the contact elements are elastically deformable and/or can each be individually biased towards the pump apparatus and/or are each resiliently mounted.
12. Method for testing an in particular biological sample,
a pump head comprising contact elements that project or protrude from a base element acting on a pump apparatus, and
the sample and/or a fluid being conveyed in the pump apparatus, in particular a pump chamber of the pump apparatus, by rotating the pump head,
characterized
in that the contact elements are moved in a sliding manner on the pump apparatus and/or in a sliding manner over a pump chamber.
13. Method according to aspect 12, characterised in that any asperities on the cartridge are in each case compensated for at least in part by the contact elements.
14. Method according to aspect 12 or 13, characterised in that a pump chamber of the pump apparatus is elastically deformed, in particular compressed, in portions by the contact elements.
15. Method according to any one of aspects 12 to 14, characterised in that the pump head and the pump apparatus are interconnected or disconnected from one another as desired and/or, upon contact with the pump apparatus, the contact elements are each elastically deformed, are each individually biased towards the pump apparatus and/or are moved towards the base element.

1-20. (canceled)

21. An analysis device for testing a sample, comprising:
a receptacle for a cartridge containing the sample; and
a pump drive for conveying the sample within the cartridge,
wherein the pump drive comprises a motor and a pump head configured to be driven by the motor,
wherein the pump head comprises a plurality of contact elements for contacting a pump apparatus of the cartridge,
wherein the pump head is formed in one piece, and
wherein the pump head includes at least one of the following features:
the pump head comprises a base element, wherein the contact elements are each configured to be moved relative to the base element, and
the contact elements are configured so that the contact elements rest on or can be brought into contact with the pump apparatus to convey the sample.

22. The analysis device according to claim 21, wherein the contact elements project from the base element, and where in the pump head is configured to be rotated by the motor.

23. The analysis device according to claim 21, wherein the contact elements each are resiliently connected to the base element and are configured to be brought into contact with the pump apparatus in a linear manner.

24. The analysis device according to claim 21, wherein the base element is disc-shaped.

25. The analysis device according to claim 21, wherein the contact elements are scoop-like or spoon-like.

26. The analysis device according to claim 21, wherein the contact elements are at least substantially V-shaped or U-shaped in cross section.

27. The analysis device according to claim 21, wherein the contact elements are each designed as at least one of a slider and sliding element.

28. The analysis device according to claim 21, wherein the contact elements are elastically deformable.

29. The analysis device according to claim 21, wherein the contact elements are configured to each be at least one of individually biased or pretensioned towards or against the pump apparatus.

30. The analysis device according to claim 21, wherein the contact elements are each resiliently mounted.

31. A cartridge for testing a sample, comprising:
a fluid system having a plurality of channels; and
a pump apparatus for conveying the sample, the pump apparatus comprising a pump chamber which is elastically deformable or compressible at least in portions thereof by means of contact elements moving over the pump chamber to convey the sample,
wherein the pump chamber is provided with at least one of an intermediate layer and a sliding layer for the contact elements.

32. The cartridge according to claim 31, wherein the cartridge comprises an at least one of a substantially planar support and a main body.

33. The cartridge according to claim 31, wherein the cartridge is designed to be card-like.

34. The cartridge according to claim 31 wherein the pump chamber is at least one of curved or in the shape of a circular arc.

35. A method for testing a sample using a pump head comprising contact elements that project or protrude from a base element acting on a pump apparatus, the method comprising:
conveying the sample in the pump apparatus by rotating the pump head; and
moving the contact elements over a pump chamber,
wherein the contact elements move over at least one of an intermediate layer and a sliding layer additionally arranged between the contact elements and the pump chamber.

36. The method according to claim 35, further comprising compensating for at least one of asperities and surface roughness on a cartridge, connected to the pump apparatus, by the contact elements.

37. The method according to claim 35, wherein a pump chamber of the pump apparatus is elastically deformed in portions by the contact elements.

38. The method according to claim 35, wherein the pump head and the pump apparatus are configured to be interconnected and disconnected from one another.

39. The method according to claim 35, wherein upon contact with the pump apparatus, the contact elements are each at least one of individually biased or pretensioned towards or against the pump apparatus.

40. The method according to claim 35, wherein upon contact with the pump apparatus, the contact elements are moved towards a base element of the pump head.
